(19) United States
(12) Patent Application Publication
(10) Pub. No.: US 2015/0371539 A1
(43) Pub. Date: Dec. 24, 2015

(54) VEHICLES ALERT SYSTEM AND DEVICE

(71) Applicant: Bobby R. Hawkins, SR., Memphis, TN (US)

(72) Inventor: Bobby R. Hawkins, SR., Memphis, TN (US)

(21) Appl. No.: 14/308,674

(22) Filed: Jun. 18, 2014

(51) Int. Cl. G08G 1/0962; G08G 1/09

(52) U.S. Cl. CPC G08G 1/0962; G08G 1/091

(57) ABSTRACT

The presence invention relates to a vehicle alert system for transmitting signals from emergency vehicles to the receiver on the non-emergency vehicles to notify drivers of the presence of an ambulance car, a fire truck, a police car, a train or a funeral escort car in the vicinity. The system identifies to the driver the type of emergency vehicle by illuminating different color lights and by overriding the audio control and the display of the multi-media center of the non-emergency vehicle or a mobile phone to playback audio telling the nature of the emergency and displaying a photo of the type of emergency vehicle within a predetermined distance.

### REFERENCE TO RELATED APPLICATIONS

This patent application claims the benefit of U.S. Provisional Application No. 61/836,476 filed on Jun. 18, 2013 the disclosure of which is incorporated herein in its entirety by reference.

### BACKGROUND OF THE INVENTION

1. Field of the Invention

The present invention relates to a vehicle alert system and more specifically relates to a vehicle alert system that notifies a driver of the presence of an ambulance car, a fire truck, a police car, a train or a funeral escort car in the vicinity. This is like a seeing eye type system and has been referred to by this inventor as the Hawkeye system.

2. Description of Related Art

Emergency vehicles are often slowed down by traffic, busy intersections, and other inconvenient scenarios. As a result, these vehicles may get stuck in traffic when their fast arrival at a destination is imperative. A delayed emergency vehicle can cause severe damage to buildings or property, further injury to individuals, and even death. Additionally, when an unexpected emergency vehicle comes through an area, individuals may get into accidents while trying to get out of the way.

The use of emergency vehicle alerting system is known in the prior art. More specifically, by way of example, U.S. Pat. No. 6,252,521 to Griffin et al. in 2001 discloses an emergency vehicle alert system that includes transmitter units mountable within emergency vehicles and non-emergency units mountable within civilian vehicles. The transmitter units and the non-emergency units via a mechanism within each non-emergency unit provides each civilian driver with an indicator of the distance between his/her civilian vehicle and the emergency vehicle.

U.S. Pat. No. 6,614,362 to Siegel in 2003 discloses a method for an emergency vehicle alert system for transmitting signals from one or more emergency vehicles to a nearby commuter vehicle includes activating an initiation switch in one or more of the emergency vehicles. A transmitter located in each of the emergency vehicles, transmits a uniquely individual signal stamp of a predefined frequency and a GPS signal. Each emergency vehicle can be identified by the uniquely individual signal stamp. Other emergency vehicles and commuter vehicles in the area with the appropriate receiver can detect the transmitted signal stamp.

U.S. Pat. No. 7,061,402 to Lawson in 2006 discloses an emergency vehicle warning system comprising a transmitter unit positioned within an emergency vehicle, and a non-emergency unit positioned within a passenger vehicle, wherein upon receipt of a radio frequency activation signal from the transmitter unit, an electronic chime within the non-emergency unit emits an audible alert, and thereby warns the driver of the passenger vehicle of the approaching emergency vehicle. The non-emergency unit additionally displays the relative position of the emergency vehicle upon a display panel. The non-emergency unit is additionally activated by sound waves associated with the siren of the emergency vehicle. The warning system alerts the driver to the approaching emergency vehicle before hearing the siren of the emergency vehicle, and thereby provides enough time for the driver of the passenger vehicle to safely pull over to the side of the road in order to allow the emergency vehicle to pass.

U.S. Pat. No. 7,663,504 to Votaw et al. in 2010 discloses an emergency vehicle transmits a Vehicle Present Signal when in transit on public roads responding to an emergency. The signal can include information relating to the type of emergency vehicle, local highway and terrain data, and the location, speed and direction of travel of the emergency vehicle. When the Vehicle Present Signal is detected by a first vehicle, a functional circuit within the first vehicle calculates the distance between the emergency vehicle and the first vehicle. If the vehicles are within a predetermined distance, a warning signal activates one or more warning systems, thereby notifying the driver of the first vehicle that an emergency vehicle is in the vicinity.

U.S. Pat. No. 8,258,979 to Lemmons et al. in 2012 discloses the emergency vehicle alarm system and method allows a user to select an emergency vehicle alert as a telematics service in a mobile vehicle. Once the user selects the alert service, a telematics operations center determines a service fee, bills the user, and debits the user's account accordingly. The emergency vehicle alert telematics service warns a civilian vehicle of an approaching emergency vehicle. The system includes a transmitter located in the emergency vehicle that transmits a signal adapted for reception by a receiving module of a telematics system located in the civilian vehicle. When the emergency vehicle signal is received by the receiving module in the civilian vehicle, an audio and/or visual alert is generated to alert the occupants of the civilian vehicle that an emergency vehicle is nearby. The civilian vehicle's telematics system may also display relative positioning of the emergency vehicle and the civilian vehicle.

### SUMMARY OF THE INVENTION

The emergency vehicles described herein include but are not limited to ambulance cars, fire trucks, police cars, trains, and funeral escort cars. The non-emergency vehicles described herein include but are not limited to private passenger vehicles, government vehicles, and passenger vehicles.

The present invention describes an emergency vehicle alert system. The device comprises an early warning system that alerts drivers when an active emergency vehicle is nearby. The device also includes a transmitter unit that mounts in an emergency vehicle and a non-emergency unit that mounts in a non-emergency vehicle. The non-emergency unit includes a receiver for receiving signals transmitted from the transmitter unit. The non-emergency unit also includes an eye with different colored lights to correlate to differing emergency vehicles, such as a red light to correspond with fire trucks and a blue light to indicate police cars. When an emergency vehicle comes within a certain distance, the appropriate color on the non-emergency unit can be activated. The non-emergency unit may further includes a dashboard-mounted warning light. The non-emergency unit can pair using wireless technology (such as Bluetooth) with an electronic control module which is installed on the non-emergency vehicle's multi-media center or on the driver's mobile phone to lower the sound volume or override the original program on the vehicle's multi-media center or on the driver's mobile phone. The electronic control module may be an application (“app”) on the non-emergency vehicle's multi-media center or the driver's or passenger's mobile phone. All the parts are compact to fit into their respective positions without causing an inconvenience. The present invention can reduce the number of accidents involving or surrounding emergency vehicles and helps emergency vehicles arrive at destinations quickly.

In an exemplary embodiment of the present invention, there is disclosed a vehicle alert system for alerting non-emergency vehicle operators of the presence of an emergency vehicle in the vicinity comprising: an emergency vehicle unit that mounts in an emergency vehicle including a transmitter to broadcast signals; and a non-emergency vehicle unit that mounts in a non-emergency vehicle including: a receiver for receiving the signals transmitted from the emergency vehicle, a colored-coded lighting component having different colored lights to signify different types of emergency vehicles, and an electronic control module for lowering a sound volume level of a multi-media center of the non-emergency vehicle or mobile phones that are within a predetermined distance from the receiver.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 shows a diagram of one embodiment of the present invention.

FIG. 2 shows a diagram of another embodiment of the present invention.

FIG. 3 shows an overhead view of the present invention which has an eye shaped multi color-coded light component.

FIG. 4 shows an overhead view of the present invention which has an eye shaped multi color-coded light component showing a color different from FIG. 3.

FIG. 5 shows an overhead view of a portion of the present invention extending from a car.

FIG. 6 shows an overhead view of the present invention mounted to the inside of a vehicle.

FIG. 7 shows a front view of the present invention displaying information on a screen inside a user's vehicle.

### DESCRIPTION OF THE PREFERRED EMBODIMENT

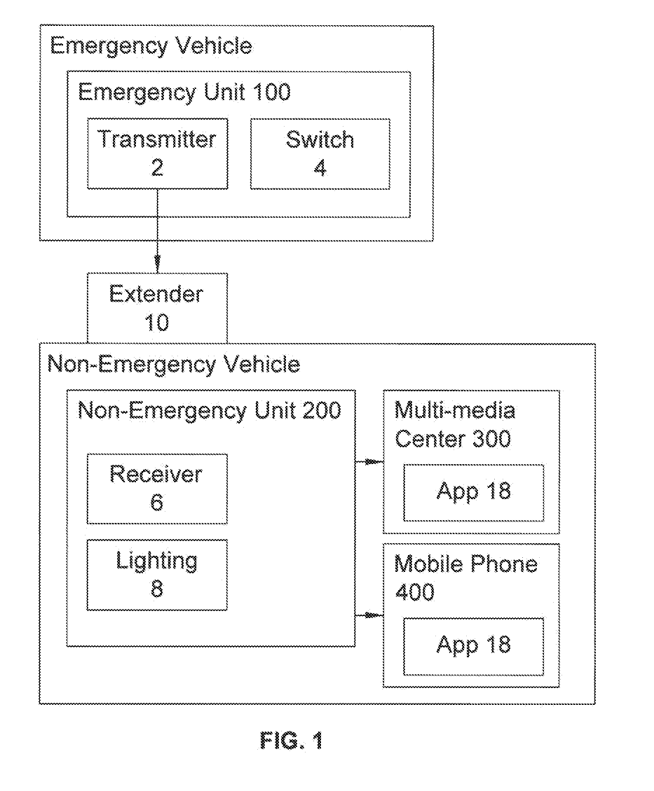

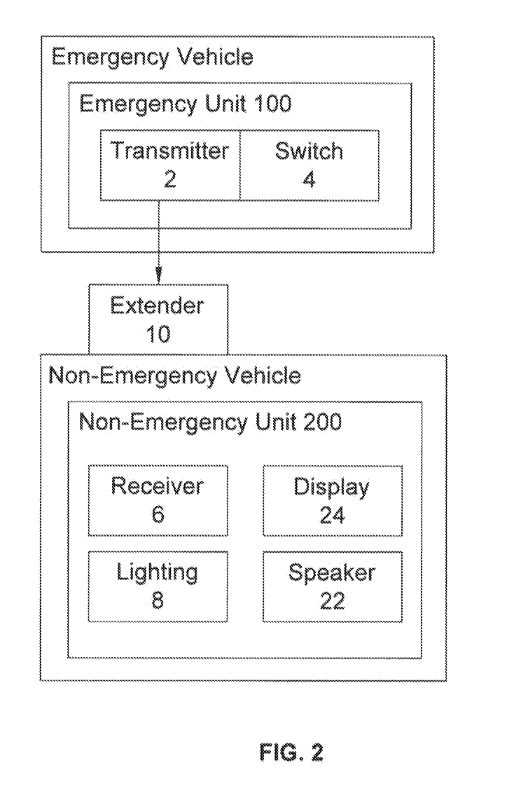

Referring now to FIGS. 1 and 2, there are shown diagrams of the present invention. The system 500 comprises an early warning system that alerts drivers when an active emergency vehicle is nearby.

The system 500 includes an emergency vehicle unit 100 that mounts in an emergency vehicle which includes a transmitter 2 with an on/off switch 4 of transmitter for turning on the transmitter to start broadcast signal when the emergency vehicle is in duty and turning off the transmitter 2 when the emergency vehicle is off duty.

The system 500 also includes a non-emergency vehicle unit 200 that mounts in a non-emergency vehicle. The non-emergency vehicle unit 200 includes a receiver 6 for receiving the signals transmitted from the active emergency vehicle. The non-emergency unit 200 also utilizes a color-coded lighting component 8 that includes an eye with different colored lights to correlate to differing emergency vehicles, such as a red light to correspond with fire trucks and ambulance, a blue light to indicate police cars, a purple light to indicate funeral escort cars, and amber light to indicate a train, to let a driver know exactly what kind of vehicle is near. Different colors may be used to signify different types of emergency vehicles in other embodiments.

The color-coded lighting component 8 may comprise a plurality of LEDs (light-emitting diode) in the form of a LED bar or light bulbs or other fashion known in the art.

The present invention notifies drivers when an active emergency vehicle is in the area so users can react accordingly and decreases the risk of emergency vehicles getting stuck in traffic. This device enables wounded patients to arrive at emergency centers faster.

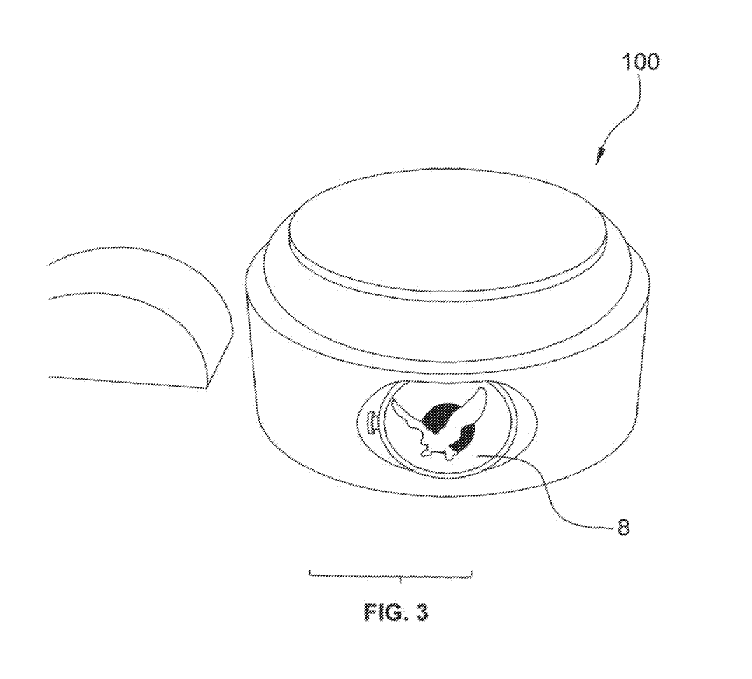

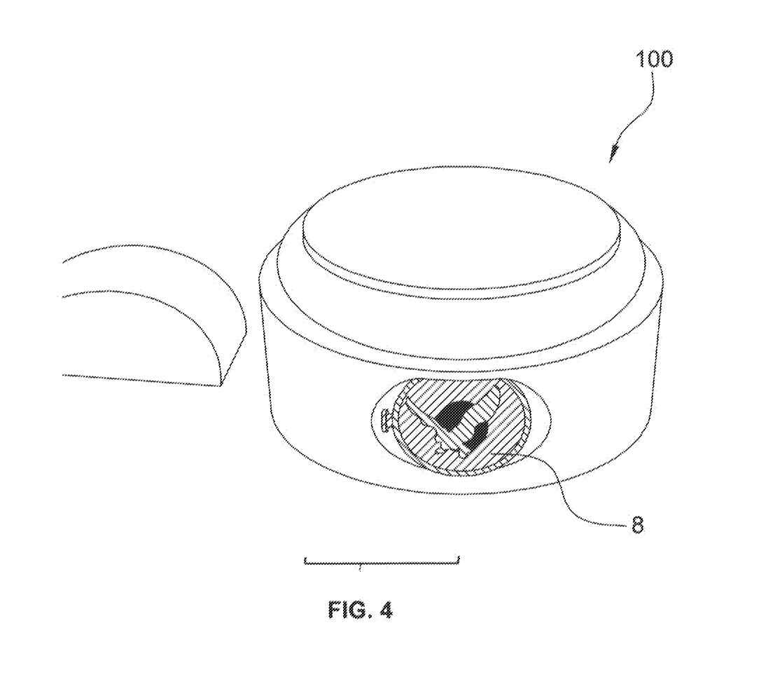

Referring now to FIGS. 3 and 4, there are shown an embodiment of the non-emergency unit 200 which has an eye with different colored lights 8 to correlate to differing emergency vehicles. FIG. 4 shows a different color from FIG. 3. The unit 100 is flat on the bottom and rounded on the top.

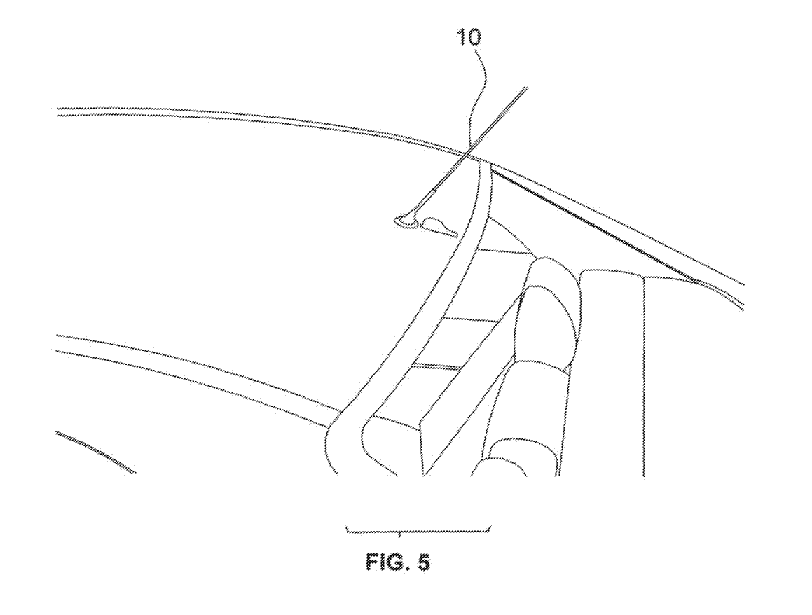

Referring now to FIG. 5, there is shown an overhead view of a portion of the present invention extending from the non-emergency vehicle. In order for the receiver 6 to retrieve accurate information from a transmitter 2 installed on an emergency vehicle, an extender 10 is provided with the device. The extender 10 is mounted to the outside of the emergency vehicle and can track an emergency vehicle when it is within a close proximity to the non-emergency vehicle unit 200. The extender 10 is similar to an antenna and aids in picking up signals and gathering accurate information on the nearby emergency vehicles.

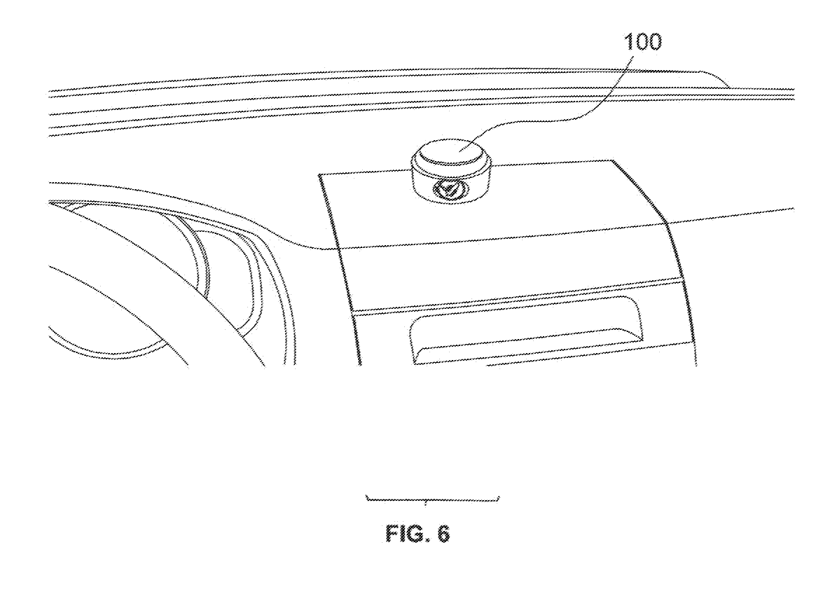

Referring now to FIG. 6, there is shown an overhead view of the present invention's non-emergency vehicle unit 200 mounted to the inside of a non-emergency vehicle. The internal component can be mounted onto the dashboard of a vehicle on the inside. A transmitter 2 with on/off switch 4 is installed in the emergency vehicle, and a receiver 6 and lighting component 8 are installed in all other non-emergency vehicles. In other embodiment, the non-emergency vehicle unit 100 may have a light in the dashboard 12 that flashes once activated. In one embodiment, there is a red flashing light that will illuminate in the dash board whenever an ambulance or fire truck comes within a ¼ mile of the passenger vehicle. A “Blue” light will flash in the dash board as well as the radio when activated by a police car. An “amber” light will flash in the dash board as well as the radio when activated by a train. A “purple” light will flash in the dash board as well as the radio when activated by a funeral escort car.

There will need to be a retro kit for older cars and trucks made prior to 2014. This device will also be helpful when it comes to weather broadcast and other emergency cases.

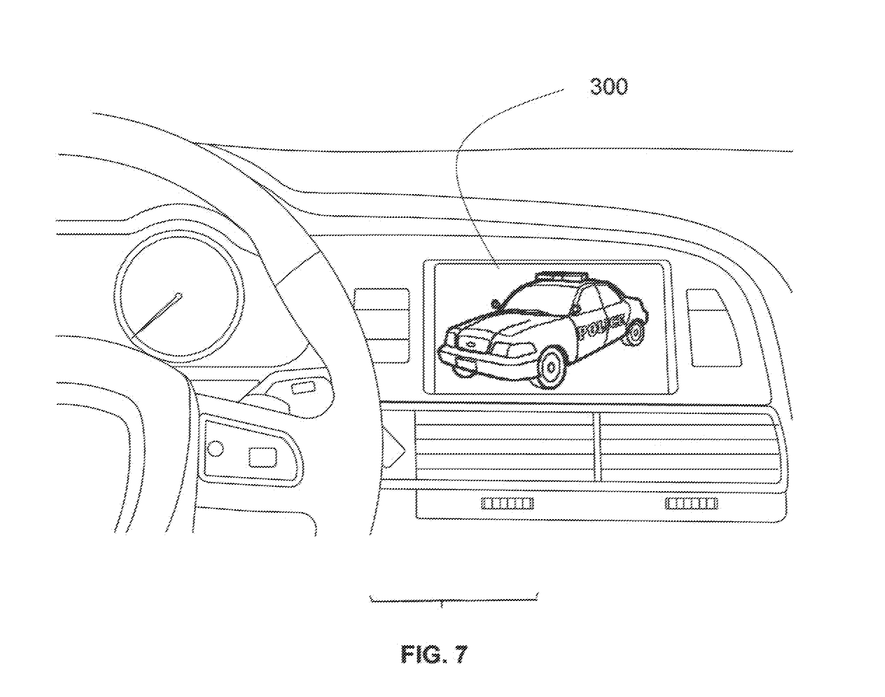

Referring now to FIG. 7, there is shown a front view of the non-emergency unit 200 of the present invention displaying an image of the type of emergency vehicle in the vicinity.

Referring back to FIG. 1, the vehicle alert system 500 further comprises an electronic control module 16. The system 500 utilizes wireless connection (such as Bluetooth or RF) or physical connections to pair the electronic control module 16 and the non-emergency unit 200. In one embodiment, the electronic control module 16 is a software application (app) 18 on the multi-media center 300 of the non-emergency vehicle or the mobile phone 400 wherein the non-emergency unit 200 is electronically coupled via wire or wireless connection to the electronic control module 16. Elaboration for an embodiment is shown below.

The transmitter 2 and the receiver 6 communicate with one another via radio frequency technology. Each of the different types of vehicles has their own unique frequency. For example, each type of the emergency vehicles (i.e. police, fire department, ambulance) has different frequencies unique to their type of vehicle. The non-emergency unit 200 is paired with the multi-media center 300 of the non-emergency vehicle via wireless frequency technology, preferably short distance wireless technology such as Bluetooth. There are several possible ways to implement this system.

The multi-media center 300 with the corresponding software 18 installed can use the multi-media center's Bluetooth to pair with the Bluetooth of the non-emergency unit 200. Similarly, a mobile phone 400 with the corresponding software application (app) 18 installed can use the mobile phone's Bluetooth to pair with the Bluetooth of the non-emergency unit 200. Once the receiver 6 receives radio frequency signal from the transmitter 2 indicating an emergency vehicle is within a predetermined distance such as ¼ mile, the non-emergency unit 200 signals the paired multi-media center 300 and overrides the audio control of the multi-media center of the non-emergency vehicle or the mobile phone of the driver so as to lower the audio of the multi-media center or mobile phone to level two volume so as to allow the driver to hear the sound of the siren of the emergency vehicle. In addition, the electronic control module may let the audio control to playback audio (voice alert) telling the nature of the emergency. Other pre-determined distance rather than ¼ mile may be used in other embodiment.

The non-emergency unit 200 may also override the display of the multi-media center 300 or the mobile phone 400 to display a photo of the type of emergency vehicle within a predetermined distance. The audio and display of the multi-media center and mobile phone return to their previous state after the emergency vehicle leaves the vicinity.

A person with ordinary skill in the art can provide the electronic control module 16 for performing the various noted functions. This device will also be helpful when it comes to weather broadcast and other emergency cases.

Referring back to FIG. 2, there is disclosed another embodiment of the system 500 which further comprises an audio player 22 and a visual display 24 in the non-emergency unit 200 to play vocal warning to alert driver and show the coming emergency vehicles so that the non-emergency unit 200 can be used alone without being connected to the multi-media center of the vehicle or the mobile phone.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A vehicle alert system for alerting non-emergency vehicle operators of the presence of an emergency vehicle in the vicinity comprising:
an emergency vehicle unit that mounts in an emergency vehicle including:
a transmitter for broadcasting signals; and
an on/off switch to control transmitting the signals for the driver of the emergency vehicle to turn on when the emergency vehicle is active and turn off when the emergency vehicle is inactive; and
a non-emergency vehicle unit that mounts in a non-emergency vehicle including:
a receiver for receiving the signals transmitted from the emergency vehicle; and
a color-coded lighting component having different colored lights to signify different types of emergency vehicles;
wherein when a particular type of an active emergency vehicle comes within a predetermined distance from the receiver, the light signifying a particular type of the emergency vehicle on the color-coded lighting component is activated.

2. The vehicle alert system of claim 1, wherein the lighting component includes a red light to signify an ambulance and fire truck, a blue light to signify a police car, a purple light signify a funeral escort car, and an amber light to signify a train.

3. The vehicle alert system of claim 1, wherein the non-emergency vehicle unit further includes a dashboard warning light.

4. The vehicle alert system of claim 1 further comprises an electronic control module for lowering a sound volume level of a multi-media center of the non-emergency vehicle or a mobile phone of the operator that is within a predetermined distance from the receiver.

5. The vehicle alert system of claim 1, wherein the electronic control module is a software application (app) on the multi-media center of the non-emergency vehicle or the mobile phone wherein the system is electronically coupled via wire or wireless connection to the electronic control module.

6. The vehicle alert system of claim 5, wherein the electronic control module overrides an audio control of the multi-media center of the non-emergency vehicle by muting the audio of the multi-media center to playback the audio telling the nature of the emergency.

7. The vehicle alert system of claim 5, wherein the electronic control module overrides an audio control of the mobile phone by muting the audio of the mobile phone to playback the audio telling the nature of the emergency.

8. The vehicle alert system of claim 5, wherein the electronic control module overrides a display of the multi-media center of the non-emergency vehicle to display a photo of the type of emergency vehicle within the predetermined distance.

9. The vehicle alert system of claim 5, wherein the electronic control module overrides a display of the driver's mobile phone to display a photo of the type of emergency vehicle within the predetermined distance.

10. The vehicle alert system of claim 5, wherein the wireless connection between the electronic control module and the non-emergency vehicle unit is Bluetooth technology or radio frequency.

11. The vehicle alert system of claim 1, wherein the non-emergency vehicle unit further includes a speaker to broadcast a vocal warning or an alerting sound or a display screen to display the incoming emergency vehicles.

12. The vehicle alert system of claim 1, wherein the non-emergency vehicle unit further includes an extender that aids in picking up signals and gathering accurate information on the nearby emergency vehicles.

13. The vehicle alert system of claim 1, wherein the communication between the transmitter and receiver is done through radio frequency.

14. The vehicle alert system of claim 5, wherein the multi-media center and mobile phone audio and display returns to its previous state after the emergency vehicle leaves the vicinity.

15. A vehicle alert device for alerting non-emergency vehicle operators of the presence of an emergency vehicle in the vicinity comprising:
a receiver for receiving the signals transmitted from an emergency vehicle; and
a color-coded lighting component having different colored lights to signify different types of emergency vehicles;
wherein when a particular type of an active emergency vehicle comes within a predetermined distance from the receiver, the light signifying a particular type of the emergency vehicle on the color-coded lighting component is activated.

16. The vehicle alert device of claim 15, wherein the color-coded lighting component includes a plurality of light-emitting diodes.

17. The vehicle alert device of claim 16, wherein the color-coded lighting component is in a shape of an eye.

18. The vehicle alert device of claim 17 further comprising an electronic control module for lowering a sound volume level of a multi-media center of the non-emergency vehicle or a mobile phone of the operator that is within a predetermined distance from the receiver.

19. The vehicle alert device of claim 18, wherein the electronic control module is a software application (app) on the multi-media center of the non-emergency vehicle or the mobile phone wherein the system is electronically coupled via wire or wireless connection to the electronic control module.

20. The vehicle alert device of claim 17 further comprises a speaker to broadcast a vocal warning or an alerting sound or a display screen to display the incoming emergency vehicles.
